(19) United States
(12) Patent Application Publication
(10) Pub. No.: US 2018/0278785 A1
(43) Pub. Date: Sep. 27, 2018

(54) COMMUNICATION CONTROL DEVICE AND COMMUNICATION CONTROL SYSTEM

(71) Applicant: FUJI XEROX CO., LTD., Tokyo (JP)

(72) Inventors: Masatoshi SUZUKI, Kanagawa (JP); Sakae OKAZAKI, Kanagawa (JP); Yuichi SUGIYAMA, Kanagawa (JP); Masahiro SUZUKI, Kanagawa (JP); Yoshiaki MORITA, Kanagawa (JP); Toshitsugu KIKUCHI, Kanagawa (JP); Yasunori ASADA, Kanagawa (JP); Shunsuke KASAHARA, Kanagawa (JP)

(73) Assignee: FUJI XEROX CO., LTD., Tokyo (JP)

(21) Appl. No.: 15/704,574

(22) Filed: Sep. 14, 2017

(30) Foreign Application Priority Data
Mar. 22, 2017 (JP) 2017-056421

(51) Int. Cl. H04N 1/00; H04N 1/32

(52) U.S. Cl. CPC H04N 1/00933; H04N 1/32053; H04N 1/00952; H04N 1/33353; H04N 2201/0082; H04N 2201/33364; H04N 2201/0081

(57) ABSTRACT

A communication control device includes a communication unit, an acquiring unit, and an adjusting unit. The communication unit transfers first image data acquired from a first processing unit to an external controller of a system, receives second image data transferred from the external controller during an interval between pieces of the first image data transferred in predetermined units, and transfers the received second image data to a second processing unit. The system includes the communication control device and the external controller connected to the communication control device by a half-duplex communication line. The acquiring unit acquires a length of a transfer period for transferring the second image data. The adjusting unit adjusts timing of acquiring the first image data in accordance with the length of the transfer period acquired by the acquiring unit.

### CROSS-REFERENCE TO RELATED APPLICATIONS

This application is based on and claims priority under 35 USC 119 from Japanese Patent Application No. 2017-056421 filed Mar. 22, 2017.

### BACKGROUND

The present invention relates to a communication control device and a communication control system.

### SUMMARY

According to an aspect of the invention, there is provided a communication control device including a communication unit, an acquiring unit, and an adjusting unit. The communication unit transfers first image data acquired from a first processing unit to an external controller of a system, receives second image data transferred from the external controller during an interval between pieces of the first image data transferred in predetermined units, and transfers the received second image data to a second processing unit. The system includes the communication control device and the external controller connected to the communication control device by a half-duplex communication line. The acquiring unit acquires a length of a transfer period for transferring the second image data. The adjusting unit adjusts timing of acquiring the first image data in accordance with the length of the transfer period acquired by the acquiring unit.

### BRIEF DESCRIPTION OF THE DRAWINGS

An exemplary embodiment of the present invention will be described in detail based on the following figures, wherein:

FIG. 1 is a block diagram illustrating a configuration of a communication control system according to the exemplary embodiment;

FIG. 2 is a top view illustrating the configuration of the communication control system according to the exemplary embodiment;

FIG. 3A is a block diagram illustrating a configuration of major units of an electrical system in a communication control device according to the exemplary embodiment;

FIG. 3B is a block diagram illustrating a configuration of major units of an electrical system in an external control device according to the exemplary embodiment;

FIG. 4 is a schematic diagram for illustrating an interval between pieces of first image data transferred in predetermined units in the communication control system according to the exemplary embodiment;

FIG. 5 is a schematic diagram for illustrating the interval between the pieces of the first image data transferred in the predetermined units in the communication control system according to the exemplary embodiment;

FIG. 6 is a top view illustrating the configuration of the communication control system according to the exemplary embodiment;

FIG. 7 is a schematic diagram for illustrating a method of controlling the timing of acquiring the first image data according to the exemplary embodiment;

FIG. 8 is a flowchart illustrating a flow of a program of a transfer control process according to the exemplary embodiment; and

FIG. 9 is a flowchart illustrating a flow of a program of a timing control process according to the exemplary embodiment.

### DETAILED DESCRIPTION

An exemplary embodiment of the present invention will be described in detail below with reference to the accompanying drawings.

A communication control device and a communication control system according to the exemplary embodiment will first be described.

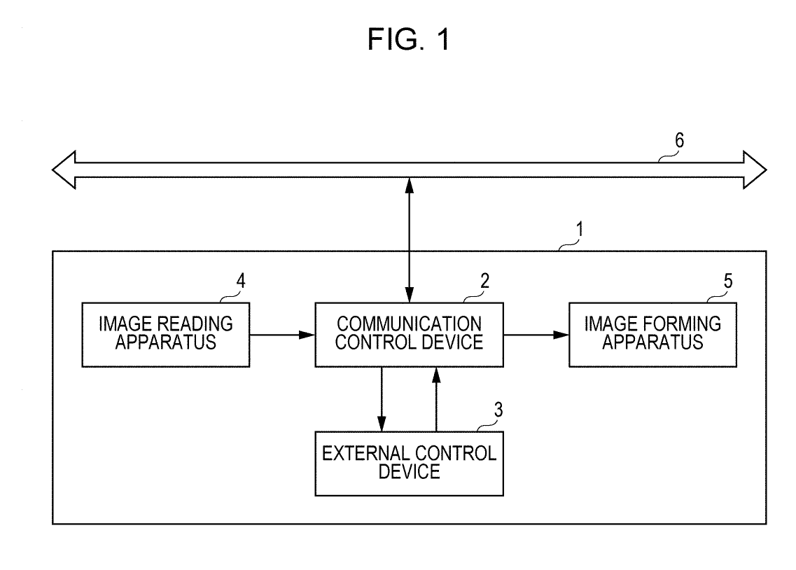

As illustrated in FIG. 1, a communication control system 1 according to the exemplary embodiment includes a communication control device 2, a external control device 3, an image reading apparatus 4, and an image forming apparatus

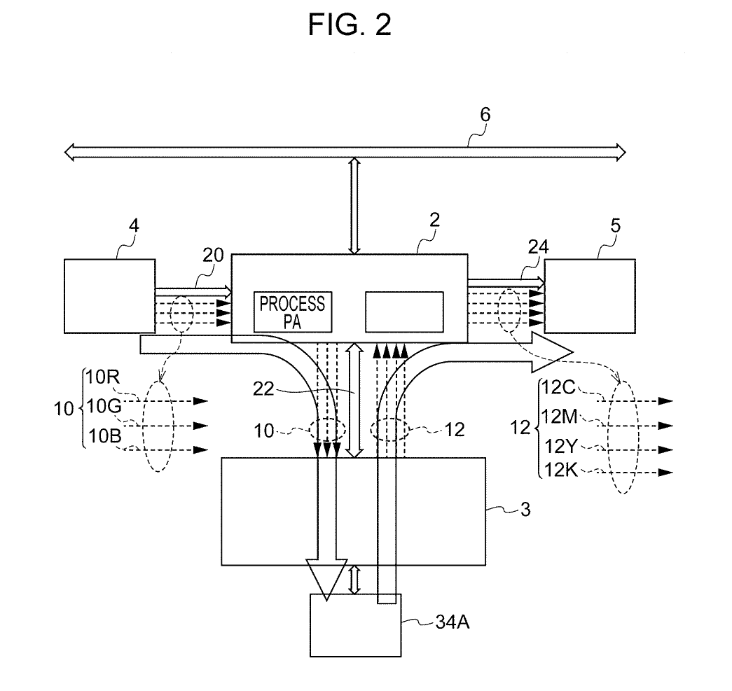

As illustrated in FIG. 2, the communication control device 2 is connected to the image reading apparatus 4 by a dedicated line 20, and acquires first image data 10 of a read image from the image reading apparatus 4. The first image data 10 is image data expressed in red, green, and blue (RGB), for example, and is transferred for each of the colors as a R signal 10R, a G signal 10G, and a B signal 10B. The communication control device 2 is further connected to the external control device 3 by a communication line 22 for performing half-duplex communication, and transfers the acquired first image data 10 to the external control device 3. The communication line 22 for performing half-duplex communication includes universal serial bus (USB) 2.0, for example.

Further, the communication control device 2 acquires from the external control device 3 second image data 12 processed from the first image data 10. The second image data 12 is image data expressed in cyan, magenta, yellow, and black (CMYK), for example, and is transferred for each of the colors as a C signal 12C, an M signal 12M, a Y signal 12Y, and a K signal 12K. The communication control device 2 is connected to the image forming apparatus 5 by a dedicated line 24, and transfers the acquired second image data 12 to the image forming apparatus 5.

The communication control device 2 is further connected to a network 6 such as the Internet, and communicates with an external device via the network 6.

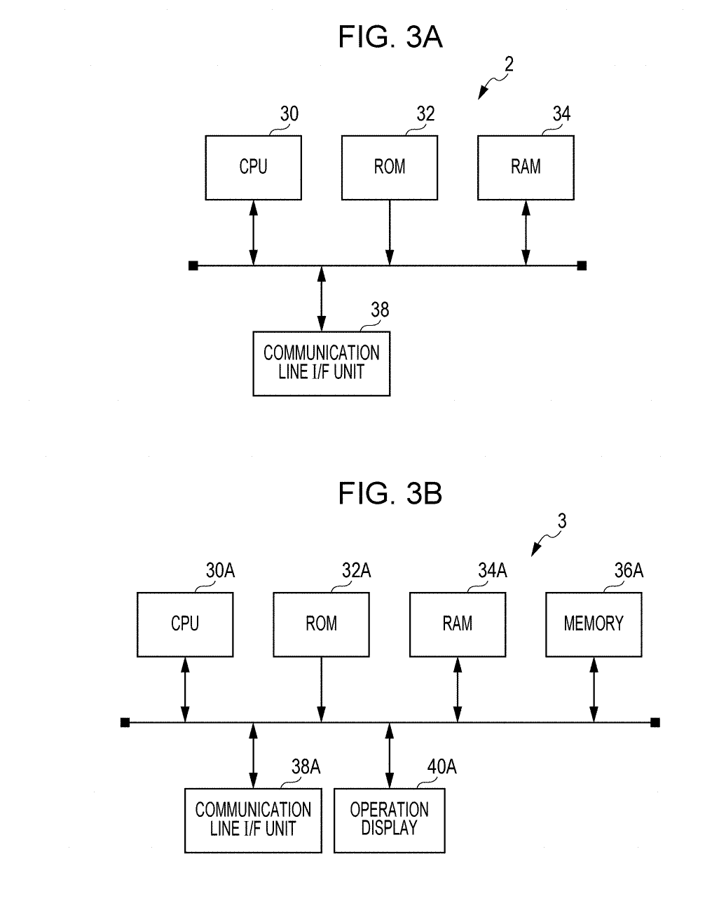

As illustrated in. FIG. 3A, the communication control device 2 is implemented through control by a central processing unit (CPU) 30 that controls the operation of the entire communication control device 2. That is, the communication control device 2 includes the above-described CPU 30, a read only memory (ROM) 32 that previously stores various programs, various parameters, and so forth, and a random access memory (RAM) 34 that is used as a work area in the execution of the various programs by the CPU 30. The communication control device further includes a communication line interface (I/F) unit 38 that transmits and receives communication information to and from the external device via the network 6.

As illustrated in FIG. 2, the external control device 3 acquires the first image data 10 from the communication control device 2, and generates the second image data 12, which is processed from the acquired first image data 10 into a data format in which the image forming apparatus 5 is capable of forming an image. The external control device 3 further transfers the processed second image data 12 to the communication control device 2.

As illustrated in FIG. 3B, the external control device 3 is implemented through control by a CPU 30A that controls the operation of the entire external control device 3. That is, the external control device 3 includes the above-described CPU 30A, which is an example of a communication unit, an acquiring unit, and an adjusting unit, a ROM 32A that previously stores various programs, various parameters, and so forth, a RAM 34A that is used as a work area in the execution of the various programs by the CPU 30A, and a memory 36A, which includes a nonvolatile memory such as a flash memory. The external control device 3 further includes a communication line interface (I/F) unit 38A that transmits and receives communication information to and from the external device. The external control device 3 further includes an operation display 40A that receives an instruction from a user to the external control device 3, and notifies the user of various information related to, for example, the operating state of the external control device 3. The operation display 40A includes, for example, a touch-panel display that displays various information and display buttons that realize receipt of operation instructions through the execution of a program, and hardware keys such as numeric keys and a start button.

The memory 36A of the external control device 3 stores various information such as image reading conditions of the image reading apparatus 4 and image forming conditions of the image forming apparatus 5. The external control device 3 processes the first image data 10 into the second image data 12 based on the image reading conditions and the image forming conditions described above.

The image reading apparatus 4 is an example of a first processing unit, and is a so-called scanner to read an image formed on a recording medium, for example, and transfer the first image data 10 of the read image to the communication control device 2.

The image forming apparatus 5 is an example of a second processing unit, and is a so-called printer to acquire the second image data 12 from the communication control device 2 and form an image on a recording medium, for example, based on the acquired second image data 12.

Hereinafter, a transfer process in which the image reading apparatus 4 transfers the first image data 10 of the read image to the communication control device 2 will be referred to as transfer A. Further, a transfer process in which the communication control device 2 transfers the acquired first image data 10 to the external control device 3 will be referred to as transfer B. Further, a transfer process in which the external control device 3 transfers to the communication control device 2 the second image data 12 processed from the acquired first image data 10 into the data format for allowing the image forming apparatus 5 to form the image will be referred to as transfer C. Further, a transfer process in which the communication control device 2 transfers the acquired second image data 12 to the image forming apparatus 5 will be referred to as transfer D.

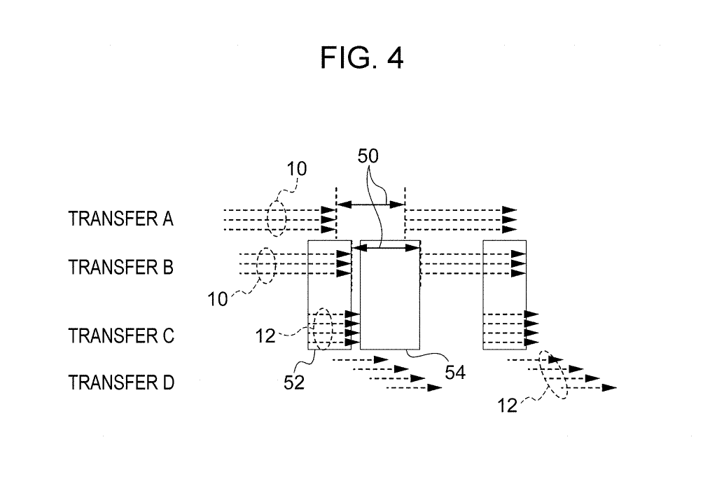

Herein, if the image reading apparatus 4 continuously reads images formed on plural recording media, a time period in which the reading is not performed arises between the completion of reading of the image on one page and the start of reading of the image on the next page. In transfer A between the image reading apparatus 4 and the communication control device 2, therefore, an interval 50 in which transfer A is not performed arises between plural consecutive pieces of the first image data 10, as illustrated in FIG. 4.

If the first image data 10 from the image reading apparatus 4 is output to the external control device 3 in process PA in FIG. 2 after being subjected only to a simple real-time process (shading correction, for example) without being temporarily stored in the communication control device 2, the interval 50 similarly arises in transfer B between the communication control device 2 and the external control device 3. Therefore, the interval 50 also arises in transfer B between pieces of the first image data 10 transferred in predetermined units (units of recording media in the exemplary embodiment) from the communication control device 2 to the external control device 3.

In such a case, it is desirable that transfer B and transfer C not be performed at the same time to reduce a communication load between the communication control device 2 and the external control device 3. If the first image data 10 and the second image data 12 are directly transferred without control of the transfer timing of the first image data 10 and the second image data 2, however, there arise a period 52 in which transfer B and transfer C are both performed and a period 54 in which neither of transfer B and transfer C is performed, thereby increasing the communication load between the communication control device 2 and the external control device 3.

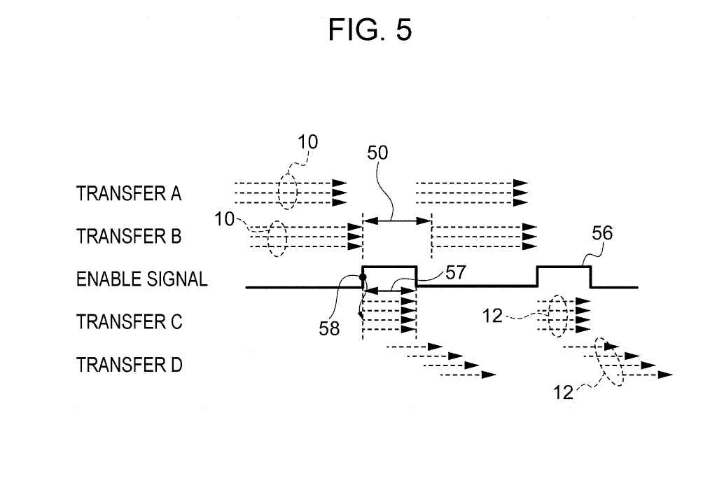

In the exemplary embodiment, therefore, the external control device 3 performs the transfer of the second image data 12 from the external control device 3 to the communication control device 2 (transfer C) during the interval 50 in which the transfer of the first image data 10 from the communication control device 2 to the external control device 3 (transfer B) is not performed, as illustrated in FIG. 5.

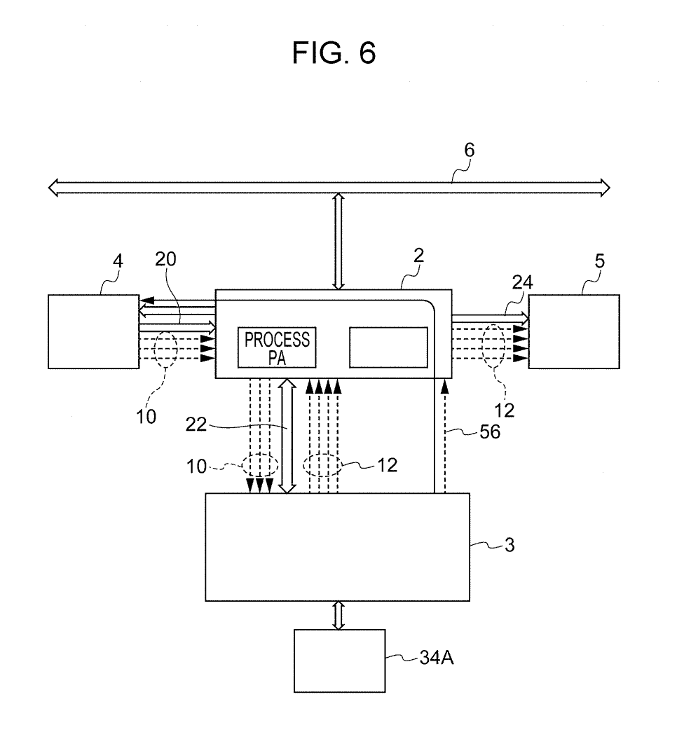

In the exemplary embodiment, therefore, the external control device 3 outputs to the communication control device 2 a data transfer enable signal (hereinafter simply referred to as the “enable signal”) 56 that indicates whether it is during or outside a transfer period 57 in which the transfer of the second image data 12 from the external control device 3 to the communication control device 2 (transfer C) is being performed, as illustrated in FIGS. 5 and 6. The enable signal 56 used in the exemplary embodiment is a signal that is in an active state during the transfer period 57 and is in an inactive state outside the transfer period 57. Further, the transfer period 57 represents the period in which the second image data 12 is being transferred, that is, the period necessary for transferring the second image data 12.

Meanwhile, the communication control device 2 acquires an actual measured value of the length of the transfer period 57 based on the enable signal 56. Further, the communication control device 2 calculates the length of the interval 50 corresponding to the actual measured value of the transfer period 57, and outputs to the image reading apparatus 4 interval information representing the calculated length of the interval 50. To reduce the time necessary for a sequence of processes of reading the images formed on the recording media and forming the read images, it is desirable to make the length of the interval 50 equal to the actual measured value of the length of the transfer period 57. In the exemplary embodiment, the length of the interval 50 corresponds to the actual measured value of the transfer period 57 added with a margin including an error of an image data transfer time in transfer B and transfer C.

The image reading apparatus 4 receives input of the interval information, and adjusts the length of the interval in reading the images formed on the plural recording media to be equal to the length of the interval represented by the input interval information. In the transfer of the plural pieces of the first image data 10, therefore, the interval 50 having an appropriate length is provided between the pieces of the first image data 10 to adjust the timing of acquisition by the communication control device 2 of the first image data 10 from the image reading apparatus 4.

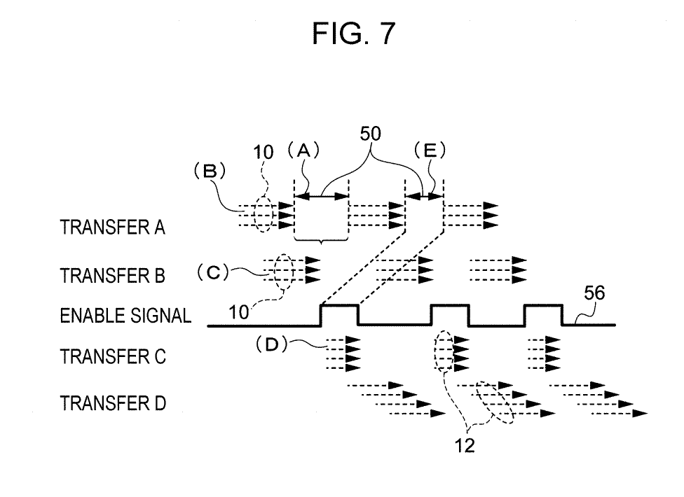

A description will be given here of a sequence of flows in the adjustment of the timing of acquisition by the communication control device 2 of first image data 10 from the image reading apparatus 4. As illustrated in (A) of FIG. 7, the length of the interval 50 is initially set to a predetermined length equal to or longer than the time necessary for transferring the second image data 12 from the external control device 3 to the communication control device 2. With the length of the interval 50 thus set to the predetermined length, the pieces of the first image data 10 are intermittently transferred in the predetermined units from the image reading apparatus 4, as illustrated in (B) of FIG. 7. As illustrated in (C) of FIG. 7, the communication control device 2 transfers the first image data 10 input from the image reading apparatus 4 to the external control device 3.

The external control device 3 processes the first image data 10 input from the communication control device 2, and transfers the processed second image data 12 to the communication control device 2 when transfer B pauses, that is, when the interval 50 starts, as illustrated in (D) of FIG. 7. Meanwhile, the communication control device 2 obtains the actual measured value of the length of the transfer period 57 from the enable signal 56, and outputs to the image reading apparatus 4 the interval information representing the length of the interval 50 corresponding to the actual measured value.

As illustrated in (E) of FIG. 7, the image reading apparatus 4 adjusts the timing, of starting the reading of the images formed on the recording media based on the length of the interval 50 represented by the interval information. For example, the image reading apparatus 4 adjusts the timing of starting the reading of the image formed on the next recording medium such that the interval between the completion of the reading of the image formed on the previous recording medium and the start of the reading of the image formed on the next recording medium equals the interval 50 having the length represented by the interval information.

Thereby, as illustrated in FIG. 7, control is performed to start and complete transfer C during the interval 50, in which transfer B is not performed, and overlap of bidirectional communications between the communication control device 2 and the external control device 3 is avoided. Further, the length of the interval 50 is adjusted to correspond to the length of the transfer period 57, and the timing of acquisition by the communication control device 2 of the first image data 10 from the image reading apparatus 4 is adjusted.

If it is possible to provide a dedicated line to each of the communication control device 2 and the external control device 3, the enable signal 56 is output with the dedicated line connecting the communication control device 2 and the external control device 3. Alternatively, if USB type-C signal is used as a bidirectional signal, for example, an unused signal may be allocated to the enable signal 56 in the alternate mode of USE type-C.

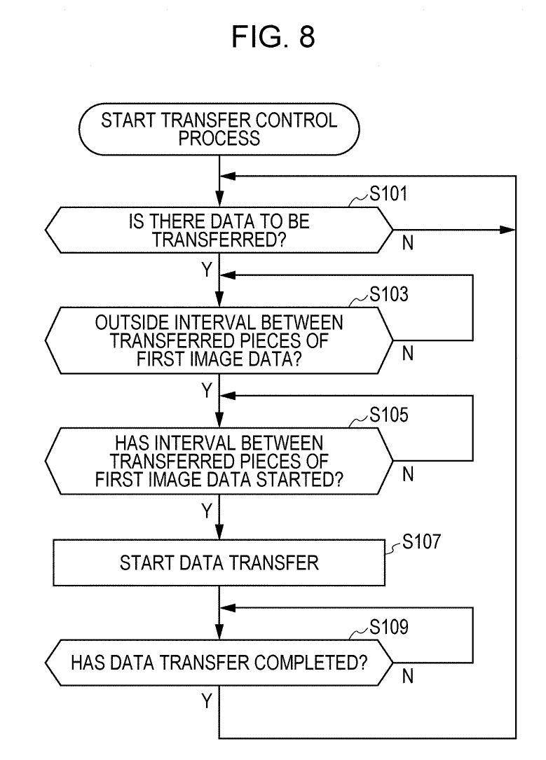

With reference to the flowchart of FIG. 8, a description will now be given of a procedure of a transfer control process executed by the external control device 3 according to the exemplary embodiment in response to input of a predetermined execution process. In the exemplary embodiment, the program of the transfer control process is previously stored in the memory 36A. However, the configuration is not limited thereto. For example, the program of the transfer control process may be received from the external device via the communication line I/F unit 38A and stored in the memory 36A. Further, the program of the transfer control process recorded on a recording medium, such as a compact disc (CD)-ROM, may be read by a device such as a CD-ROM drive to thereby execute the transfer control process.

At step S101, the CPU 30A determines whether or not the second image data 12 to be transferred to the communication control device 2 is present. If it is determined at step S101 that the second image data 12 to be transferred to the communication control device 2 is present (Y at step S101), the CPU 30A proceeds to step S103. Further, if it is determined at step S101 that the second image data 12 to be transferred to the communication control device 2 is absent (N at step S101), the CPU 30A repeats the present step until it is determined that the second image data 12 to be transferred to the communication control device 2 is present.

At step S103, the CPU 30A determines whether or not it is outside the interval 50, in which transfer B is not performed. If it is determined at step S103 that it is outside the interval 50 (Y at step S103), the CPU 30A proceeds to step S105. Further, if it is determined at step S103 that it is not outside the interval 50 (N at step S103), the CPU 30A repeats the present step until it is determined that it is outside the interval 50.

At step S105, the CPU 30A determines whether or not the interval 50, in which transfer B is not performed, has started. If it is determined at step S105 that the interval 50 has started (Y at step S105), the CPU 30A proceeds to step S107. If it is determined at step S105 that the interval 50 has not started (N at step S105), the CPU 30A repeats the present step until the interval 50 starts.

The respective processes of steps S103 and S105 are performed in consideration that the length of the interval 50 and the length of the transfer period 57 are made correspond to each other. That is, the processes of steps S103 and S105 are performed to avoid a failure to complete transfer C within the interval 50 due to the start of transfer C during the interval 50 despite the correspondence made between the length of the interval 50 and the length of the transfer period 57.

At step S107, the CPU 30A starts transferring the second image data 12 to the communication control device 2.

At the next step S109, the CPU 30A determines whether or not the transfer started at step S107 has completed. If it is determined at step S109 that the transfer has completed (Y at step S109), the CPU 30A returns to step S101. Further, if it is determined at step S109 that the transfer has not completed (N at step S109), the CPU 30A repeats the present step until it is determined that the transfer has completed.

In the exemplary embodiment, the external control device 3 thus transfers the second image data 12 during the interval 50, in which transfer B is not performed.

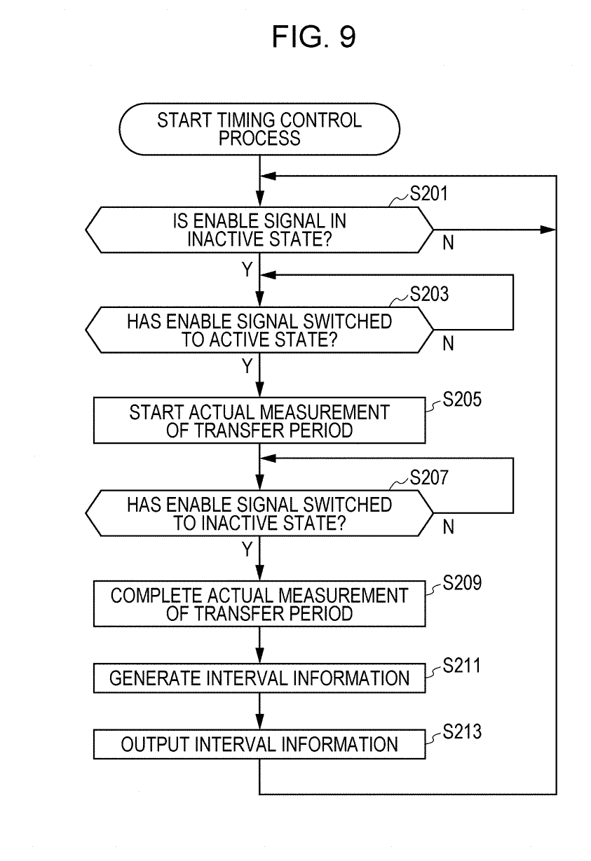

With reference to the flowchart of FIG. 9, a description will now be given of a procedure of a timing control process executed by the communication control device 2 according to the exemplary embodiment in response to input of a predetermined execution process. In the exemplary embodiment, the program of the timing control process is previously stored in the ROM 32. However, the configuration is not limited thereto.

At step S201, the CPU 30 determines whether or not the enable signal 56 is in the inactive state. If it is determined at step S201 that the enable signal 56 is in the inactive state (Y at step S201), the CPU 30 proceeds to step S203. Further, if it is determined at step S201 that the enable signal 56 is in the active state (N at step S201), the CPU 30 repeats the present step until the enable signal 56 switches to the inactive state.

At step S203, the CPU 30 determines whether or not the enable signal 56 has switched to the active state. If it is determined at step S203 that the enable signal 56 has switched to the active state (Y at step S203), the CPU 30 proceeds to step S205, if it is determined at step S203 that the enable signal 56 has not switched to the active state (N at step S203), the CPU 30 repeats the present step until the enable signal 56 switches to the active state.

At step S205, the CPU 30 starts a timer, for example, to start actual measurement of the transfer period 57.

At step S207, the CPU 30 determines whether or not the enable signal 56 has switched to the inactive state. If it is determined at step S207 that the enable signal 56 has switched to the inactive state (Y at step S207), the CPU 30 proceeds to step S209. Further, if it is determined at step S207 that the enable signal 56 has not switched to the inactive state (N at step S207), the CPU 30 repeats the present step until the enable signal 56 switches to the inactive state.

At step S209, the CPU 30 stops the timer, for example, to complete the actual measurement of the transfer period 57.

At step S211, the CPU 30 generates the interval information representing the length of the interval 50 corresponding to the actual measured value of the period of the active state of the enable signal 56, that is, the actual measured value of the transfer period 57.

At step S213, the CPU 30 outputs the generated interval information to the image reading apparatus 4, and completes the execution of the program of the present timing control process.

As described above, in the exemplary embodiment, the communication control device 2 transfers the first image data 10 acquired from the image reading apparatus 4 to the external control device 3 of the communication control system 1, which includes the communication control device 2 and the external control device 3 connected to the communication control device 2 by the half-duplex communication line 22. Further, the communication control device 2 receives the second image data 12 transferred from the external control device 3 during the interval 50 between the pieces of the first image data 10 transferred in the predetermined units, and transfers the received second image data 12 to the image forming apparatus 5. Further, the communication control device 2 acquires the actual measured value of the length of the transfer period 57 necessary for transferring the second image data 12. Further, the communication control device 2 adjusts the timing of acquiring the first image data 10 in accordance with the acquired actual measured value.

The communication control device 2 may need to receive input of another signal different from the first image data 10 and the second image data 12, and transfer the input signal to the external control device 3.

In such a case, if (bandwidth necessary for transfer B) (bandwidth necessary for transfer C) and (bandwidth capacity of communication line 22)≥(bandwidth necessary for transfer B bandwidth+necessary for transfer of another signal) hold, the transfer of the signal, does not interfere with the transfer of the first image data 10 and the second image data 12 even if the signal is transferred to the external control device 3 at any time.

Further, if (bandwidth necessary for transfer B)≥(bandwidth necessary for transfer C+bandwidth necessary for transfer of another signal) holds, and if the signal is transferred to the external control device 3 during the interval 50, in which transfer B is not performed, the interference with the transfer of the first image data 10 and the second image data 12 by the transfer of the signal is avoided.

Examples of another signal different from the first image data 10 and the second image data 12 include image forming data f an instruction to perform image formation input to the communication control a device 2 from the external device, such as a personal computer (PC), connected to the communication control device 2, error information input to the communication control device from the image reading apparatus 4 (such as sensor information as to jam error, for example), and error information input to the communication control device 2 from the image forming apparatus 5 (such as sensor information as to jam error, sheet shortage, and open tray, for example).

Further, depending on the image reading conditions in the image reading by the image reading apparatus 4, the data size of the first image data 10 varies, resulting in variations of the transfer time of transfer B. Further, variations of the data size of the first image data 10 result in variations of the data size of the second image data 12 obtained through the processing of the first image data 10. Further, depending on the image forming conditions in the image formation by the image forming apparatus 5, the data size of the second image data 12 varies, resulting in variations of the transfer time of transfer C.

In the exemplary embodiment, therefore, the external control device :3, which stores various information such as the image reading conditions and the image forming conditions, may transfer the various information to the communication control device 2 when the image reading apparatus 4 starts the image reading, for example. In this case, when generating the interval information representing the length of the interval 50 corresponding to the actual measured value, the communication control device 2 calculates the length of the interval 50 in consideration of the above-described various information input from the external control device 3.

As described above, in the exemplary embodiment, a description has been given of the case in which the communication control device 2 generates the interval information. However, the configuration is not limited thereto. For example, the external control device 3 may actually measure the length of the period of the active state of the enable signal 56, generate the interval information based on factors such as the image reading conditions, the image forming conditions, and the actual measured value, and transfer the generated interval information to the communication control device 2.

Further, the configurations of the communication control device 2 and the external control device 3 described in the foregoing exemplary embodiment (see FIGS. 1 to 3B and FIG. 6) are illustrative. That is, it is needless to say that the deletion of an unnecessary part and the addition of a new part are possible within a scope not departing from the gist of the present invention.

Further, the procedures of the processes of the various programs described in the foregoing exemplary embodiment (see FIGS. 8 and 9) are also illustrative. That is, it is needless to say that the deletion of an unnecessary step, the addition of a new step, and a change in the order of processes are possible within a scope not departing from the gist of the present invention.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A communication control device comprising:
a communication unit that transfers first image data acquired from a first processing unit to an external controller of a system, receives second image data transferred from the external controller during an interval between pieces of the first image data transferred in predetermined units, and transfers the received second image data to a second processing unit, the system including the communication control device and the external controller connected to the communication control device by a half-duplex communication line;
an acquiring unit that acquires a length of a transfer period for transferring the second image data; and
an adjusting unit that adjusts timing of acquiring the first image data in accordance with the length of the transfer period acquired by t he acquiring unit.

2. The communication control device according to claim 1, wherein the adjusting unit adjusts the timing of acquiring the first image data to make the interval have a predetermined length equal to or longer than the length of the transfer period, and
wherein if the acquiring unit acquires the length of the transfer period, the adjusting unit adjusts the timing of acquiring the first image data to make the interval have a length corresponding to the length of the transfer period.

3. The communication control device according to claim 1, wherein the acquiring unit acquires from the external controller a signal indicating whether or not the transfer period is continuing, and calculates the length of the transfer period from the signal.

4. The communication control device according to claim 2, wherein the acquiring unit acquires from the external controller a signal indicating whether or not the transfer period is continuing, and calculates the length of the transfer period from the signal.

5. A communication control system comprising:
the communication control device according to claim 1; and
an external control device that receives input of the first image data from the communication control device, processes the input first image data into the second image data, and outputs the processed second image data to the communication control device.
